(19) United States
(12) Patent Application Publication
(10) Pub. No.: US 2021/0408897 A1
(43) Pub. Date: Dec. 30, 2021

(54) SNUBBER CIRCUITS CONTROLLED BY OUTPUTS OF TRANSFORMERS

(71) Applicant: HEWLETT-PACKARD DEVELOPMENT COMPANY, L.P., SPRING, TX (US)

(72) Inventors: CHUN-YI LAI, TAIPEI CITY (TW); CHIH-TING LAI, TAIPEI CITY (TW); MING-FENG HSIEH, TAIPEI CITY (TW)

(21) Appl. No.: 16/641,913

(22) PCT Filed: Dec. 8, 2017
(86) PCT No.: PCT/US2017/065387

§ 371 Date: Feb. 25, 2020

(51) Int. Cl. H02M 1/34; H02M 3/335; G06F 1/26; G06F 1/28

(52) U.S. Cl. CPC H02M 1/348; H02M 3/33523; H02J 7/02; G06F 1/28; G06F 1/266

(57) ABSTRACT

An example power converter device includes a transformer including a primary winding electromagnetically coupled to a secondary winding. The transformer is to receive power at an input voltage and to output power at a selectable output voltage. The device further includes a snubber circuit, a switch to selectively couple the snubber circuit to the transformer, and a switch control circuit to control the switch to couple or decouple the snubber circuit to the transformer based on a selected output voltage of the transformer.

### BACKGROUND

Power converters are used to provide electrical power to a variety of electronic devices, such as computers and the like. A converter typically converts wall or mains power into a form that is useable by the electronic device. This often includes converting alternating current (AC) at high voltage to direct current (DC) at low voltage. A power converter may include a transformer, which may be implemented as a pair, or more, of inductive windings.

### BRIEF DESCRIPTION OF THE DRAWINGS

FIG. 1 is a block diagram of an example power converter device.

FIG. 2 is a circuit diagram of another example power converter device.

FIG. 3 is a schematic diagram of an example switch winding coupled to an example secondary winding of the example circuit of FIG. 2.

FIG. 4 is a block diagram of an example power adaptor.

FIG. 5 is a block diagram of an example system with a snubber enabled.

FIG. 6 is a block diagram of an example system with a snubber disabled.

FIG. 7 is a flowchart of an example method of controlling a snubber circuit.

### DETAILED DESCRIPTION

Snubbers are often used to protect inductive converters against voltage spikes. Snubbers tend to introduce inefficiency and a snubber may cause some amount of power to be lost.

A switch may be provided to control a snubber. The switch may be to enable or disable a snubber of a multi-voltage output converter. Such a converter may have a selectable output of 5 V, 9 V, 12 V, 15 V, and 20 V, for example. The snubber may be enabled at a higher output voltage and may be disabled at a lower voltage when voltage transients are potentially less harmful. The converter's efficiency may increase when the snubber is disabled.

To enable and disable the snubber, a switch winding may be coupled to a secondary winding of a converter's transformer. The switch winding may be used to sense the output voltage of the converter and control the switch to enable or disable the snubber accordingly.

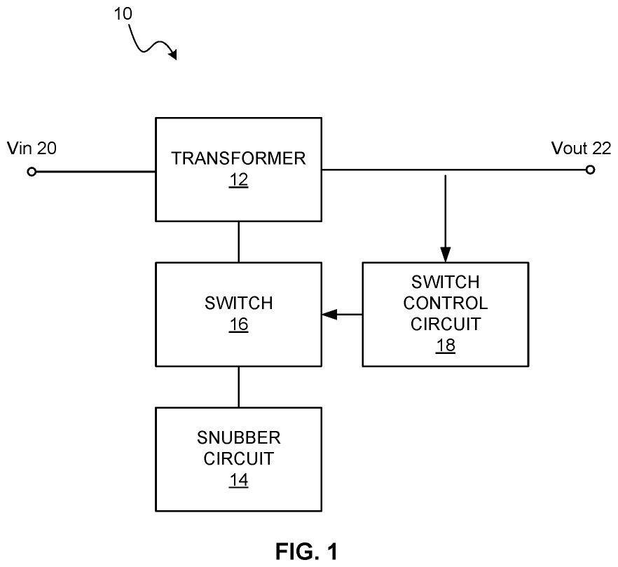

FIG. 1 shows an example power converter device 10. The power converter device 10 includes a transformer 12, a snubber circuit 14, a switch 16, and a switch control circuit. The power converter device 10 may be provided to a power adaptor, such as a power adaptor that is to provide power to a computer device.

The transformer 12 may include a primary winding electromagnetically coupled to a secondary winding, the transformer to receive power at an input voltage 20 and to output power at a selectable output voltage 22. The input may be an AC power source, which may be external to the power converter device 10. For example, the power converter device 10 may be a device that plugs into a consumer power source, such as a wall or mains power outlet. The power source may provide an input voltage 20 of 110/115/120 Volts AC (VAC), 230 VAC, or similar. The output voltage 22 may be DC at a selectable output of 5 V, 9 V, 12 V, 15 V, 20 V, or similar. The power converter device 10 may be a flyback converter.

The snubber circuit 14 is selectively coupled to the transformer through the switch. When the switch 16 is off, the snubber circuit 14 is disabled and does not work to suppress transient voltage spikes. When the switch 16 is on, the snubber circuit 14 is enabled to suppress transient voltage spikes.

The switch 16 may include a bipolar junction transistor (BJT) or similar, such as an NPN BJT.

The switch control circuit 18 is connected to the switch 16 to control the switch to couple or decouple the snubber circuit 14 to the transformer 12 to enable or disable the functionality of the snubber circuit 14. The switch control circuit 18 may drive a base or gate of the switch 16.

The switch control circuit 18 is coupled to the output of the transformer 12 and is responsive to the output voltage 22. The switch control circuit 18 selectively enables or disables the snubber circuit 14 based on a selected output voltage 22 of the transformer 12. To achieve this, the switch control circuit 18 may have a threshold voltage. On one side of the threshold voltage the switch control circuit 18 disables the snubber circuit 14, and on the other side of the threshold voltage the switch control circuit 18 enables the snubber circuit 14. In this example, the switch control circuit 18 disables the snubber circuit 14 when the output voltage 22 of the transformer 12 is below a threshold voltage and enables the snubber circuit 14 when the output voltage 22 is above the threshold voltage.

An example threshold voltage is 17.5 V. As such, in the example above, the snubber circuit 14 is disabled when the output voltage 22 of the transformer 12 is 5 V, 9 V, 12 V, or 15 V, and the snubber circuit 14 is enabled when the output voltage 22 of the transformer 12 is 20 V.

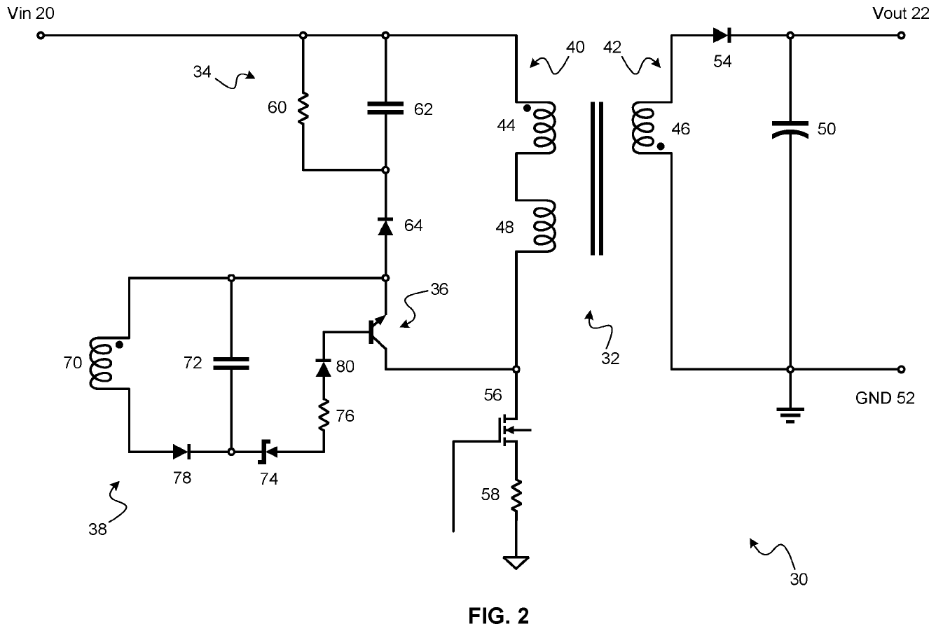

FIG. 2 shows a circuit diagram of another example power converter device 30. The power converter device 30 includes a transformer 32, a snubber circuit 34, a switch 36, a switch control circuit 38.

The transformer 32 includes a primary side 40 and a secondary side 42. The primary side 40 includes a primary winding 44 electromagnetically coupled to a secondary winding 46 of the secondary side 42. The primary side 40 may further include transformer leakage inductance 48 in series with the primary winding 44. The secondary side 42 may further include a capacitor 50 in parallel with the secondary winding 46 between an output voltage 22 and ground 52. A rectifying diode 54 may be provided between the secondary winding 46 and the capacitor 50 to provide DC output. The primary side 40 may further include a power switch 56, such as a metal-oxide-semiconductor field-effect transistor (MOSFET), and resistor 58 in series with the primary winding 44 to selectively provide an input voltage 20 to drive the transformer 32. The power switch 56 is turned on to operate the transformer 32.

The snubber circuit 34 may be in parallel with the primary winding 44. The snubber circuit 34 may include a resistor 60 and a capacitor 62 in parallel, which are in series with a snubber diode 64. The snubber circuit 34 may operate to clamp a voltage spike on the power switch 56 to reduce or prevent voltage spike overstress across the power switch 56 during the transition from on to off.

The switch 36 may be in series with the snubber circuit 34, so that the circuit made up of the switch 36 and the snubber circuit 34 is in parallel with the primary winding 44. The switch 36 may include a BJT having an emitter connected to the snubber circuit 34 and a collector connected between the primary winding 44 and the power switch 56.

The switch control circuit 38 may be connected between the snubber circuit 34 and the control input of the switch 36, such as a base of a BJT.

The switch control circuit 38 may include a switch winding 70 and parallel capacitor 72. A rectifier diode 78 may be provided between the switch winding 70 and the capacitor 72. A node at one end of the switch winding 70 and capacitor 72 may be connected to the control input of the switch 36 via a Zener diode 74 oriented to turn on the switch to couple the snubber circuit 34 to the transformer 32 during breakdown of the Zener diode 74. A driving resistor 76 may be provided in series with the Zener diode 74, such as between the Zener diode 74 and the control input of the switch 36, and a diode 80 may be provided at the control input of the switch 36.

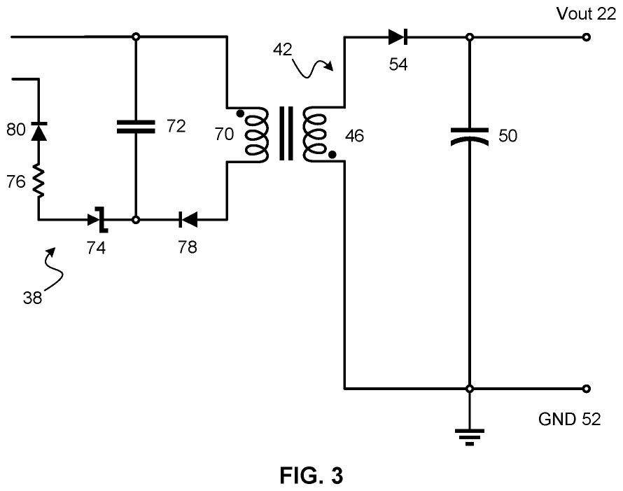

The switch winding 70 of the switch control circuit 38 may be electromagnetically coupled to the secondary winding 46 of the transformer 32, as shown in FIG. 3. A turn ratio between the switch winding 70 and the secondary winding 46 may be selected to sense a proportional voltage of the DC output 22 and generate a detection signal at the switch control circuit 38.

The detection signal may be considered a voltage provided to the Zener diode 74 by the capacitor 72. When this sense voltage is high enough to cause the Zener diode 74 to breakdown, the switch 36 turns on to enable the snubber circuit 34 by coupling the snubber circuit 34 to the transformer 32. When this voltage is not sufficiently high, the switch 36 remains turned off and the snubber circuit 34 is disabled and decoupled from the transformer 32.

The secondary winding 46 may be required to deliver output voltage 22 at selectable levels, such as those discussed elsewhere herein. A ratio of turns between the switch winding 70 and the secondary winding 46, as well as the properties of the capacitor 72 and resistor 76, may be selected to define a detection signal that turns on the switch 36 when a threshold voltage is detected at the secondary winding 46. The threshold voltage may be selected to be between a high output voltage 22 that is to have the snubber circuit 34 enabled and a lower output voltage 22 that is to have the snubber circuit 34 disabled.

It should be apparent that the switch winding 70 allows the example power converter device 30 to remain galvanically isolated.

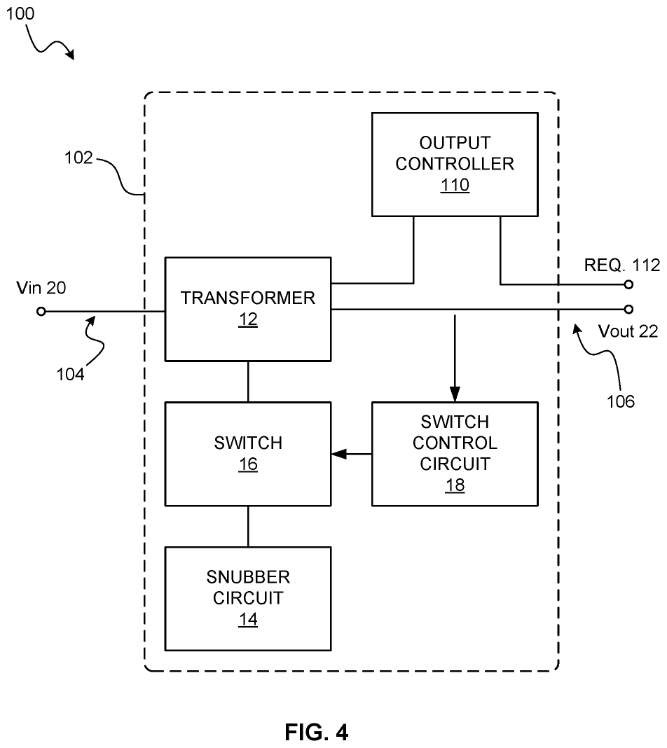

FIG. 4 shows an example power adaptor 100. The other devices and circuits described herein may be referenced for description that is not repeated here. Like refence numerals denote like components.

The power adaptor 100 may include a housing 102, an input terminal 104, and an output terminal 106. The input terminal 104 and output terminal 106 may provide power and signal to components within the housing 102. Cables may be provided to connect the power adaptor 100 to a source to provide an input voltage 20 and to a device to receive an output voltage 22. Each cable may include a conductor that may be permanently or removably connected to each input terminal 104 and output terminal 106. The power adaptor 100 may be a Universal Serial Bus™ (USB) Power Delivery (PD) adaptor.

The power adaptor 100 may include a transformer 12 to convert the input voltage 20 to the output voltage 22 and a snubber circuit 14 that is selectively enabled by a switch 16. The switch 16 may be driven by a switch control circuit 18 that senses the output voltage 22 and determines whether or not the snubber circuit 14 is to be enabled. The switch 16 and switch control circuit 18 may contain components as shown in FIG. 2.

The power adaptor 100 may further include an output controller 110 connected to the transformer 12. The output controller 110 may be to receive a request signal 112 from a device to which the adaptor 100 is to provide power. The request signal 112 may indicate an output voltage 22 that is requested by the device. The output controller 110 may be to control the transformer 12 to provide the requested output voltage 22.

The output controller 110 may include a microcontroller or other digital circuit that communicates with a device using a communications protocol, such as a protocol provided by USB PD. The output controller 110 may be connected to a secondary side of the transformer 12 to control a secondary winding to provide an output voltage 22 at the requested level. The switch control circuit 18 is responsive to the output voltage 22 provided by the secondary winding and may enable the snubber circuit 14 when the output voltage 22 is high and disable the snubber circuit 14 when the output voltage 22 is low.

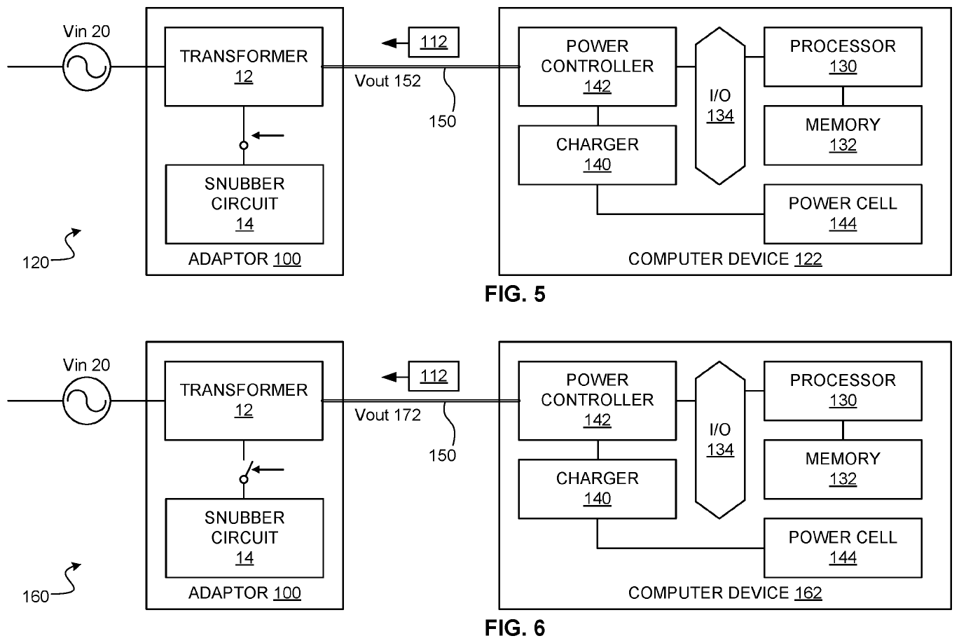

FIG. 5 shows a system 120 that includes a power adaptor 100 and a computer device 122. The power adaptor 100 may be as discussed elsewhere herein and may include any of the converters and circuits described herein. The computer device 122 may be a notebook computer, a desktop computer, a smartphone, a tablet computer, a server, a printer, or the like. The computer device 122 may include a processor 130, memory 132, an input/output interface 134, a charger 140, a power controller 142, and a power cell 144. The computer device 122 may further include other components, such as a display device, an input device, a network communications adaptor, non-volatile storage, and similar.

The processor 130 may include a central processing unit (CPU), a microcontroller, a microprocessor, a processing core, a field-programmable gate array (FPGA), or similar. The processor 130 may execute instructions stored in memory 132, such as instructions to execute an operating system and an application. The memory 132 may include a non-transitory machine-readable storage medium capable of storing executable instructions such as random-access memory (RAM), read-only memory (ROM), flash memory, electrically-erasable programmable read-only memory (EEPROM), and similar.

The I/O interface 134 may include a northbridge, a southbridge, a bus, and similar. The I/O interface 134 may provide for communications among the components of the computer device 122, such as communications between the processor 130 and the power controller 142.

The charger 140 may include a circuit that provides power received from the power adaptor 100 to the power cell 144, which may be provided in a removable battery, so as to charge the power cell 144.

The power controller 142 may include a circuit to connect to the power adaptor 100 and receive power from the power adaptor 100. The power controller 142 may control the provision of power to the charger 140 and to other components of the computer device 122. The power controller 142 may include a microcontroller, such as an embedded controller, a PD controller, or similar device capable of executing instructions stored at the power controller 142 or elsewhere in the computer device 122. The power controller 142 may implement power management by interfacing with the power adaptor 100 and requesting a specific level of electrical power. The power controller 142 may be a PD-aware device.

In operation, the power controller 142 may transmit a request signal 112 to the power adaptor 100 via a connecting cable 150. The request signal 112 may indicate that power is to be delivered at a requested voltage. In response to receiving the request signal 112, the power adaptor 100 may provide power at a requested voltage 152. In this example, a voltage 152 exceeding a threshold value is requested and delivered. Hence, the adaptor 100 senses the delivered voltage 152, compares the delivered voltage 152 to the threshold, and enables the snubber circuit 14.

FIG. 6 shows a system 160 that includes a power adaptor 100 and a computer device 162. The computer device 162 may be different, similar, or identical to the computer device 122 of FIG. 5, except that a different voltage is requested. The power adaptor 100 is the same adaptor as shown in FIG. 5 and supports multiple output voltages.

In operation, the power controller 142 may transmit a request signal 112 that requests a lower voltage, as compared to the example above with respect to FIG. 5. In response, the power adaptor 100 may provide power at a requested voltage 172. In this example, the voltage 172 does not exceed the threshold value. Hence, the adaptor 100 senses the delivered voltage 172, compares the delivered voltage 172 to the threshold, and disables the snubber circuit 14.

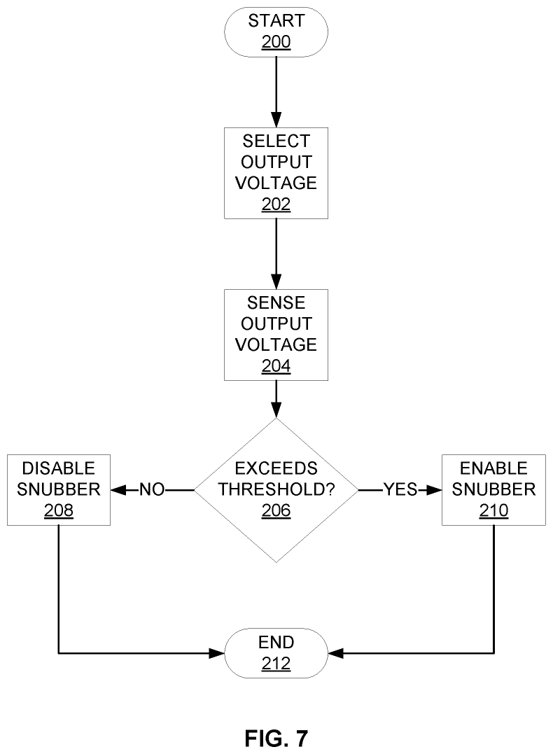

FIG. 7 shows a flowchart of an example method of enabling and disabling a snubber. The method may be used with any of the devices and circuits discussed herein. The method begins at block 200.

At block 202, an output voltage is selected for a power converter or adaptor capable of delivering DC power at different output voltages. This may include receiving a signal from a powered device indicating an output voltage required.

At block 204, the voltage of the actual power delivered is sensed. This may include using a sense winding coupled to a transformer's secondary winding to sense the output voltage of the transformer.

At block 206, the sense voltage is compared to a threshold. The threshold may be defined by a turn ratio of the sensing winding to the secondary winding of the transformer. The sense voltage is indicative of the output voltage of the transformer and need not be the same voltage. The sense voltage may be proportional to the output voltage, and such proportionality may be linear or non-linear. Comparison to the threshold may include using the sense voltage to try to cause a diode to operate at breakdown.

When the sense voltage does not exceed the threshold, the snubber is disabled, at block 208. This may include the sense voltage failing to reach a breakdown voltage and thereby failing to turn off a transistor that connects the snubber to the transformer.

When the sense voltage exceeds the threshold, the snubber is enabled, at block 210. This may include the sense voltage reaching a breakdown voltage and thereby turning on the transistor that connects the snubber to the transformer.

The method ends at block 212 and may be repeated each time an output voltage is selected.

It should be apparent from the above that a switch may be actively driven to selectively couple and decouple a snubber circuit to a transformer based on an output voltage of the transformer. Disabling the snubber for certain output voltages may allow a multi-output converter or power adaptor to operate more efficiently, such as by reducing snubber loss. The ability to enable the snubber circuit at another voltage allows for voltage spikes and transients to be suppressed when needed.

It should be recognized that features and aspects of the various examples provided above can be combined into further examples that also fall within the scope of the present disclosure.

1. A power converter device comprising:
a transformer including a primary winding electromagnetically coupled to a secondary winding, the transformer to receive power at an input voltage and to output power at a selectable output voltage;
a snubber circuit;
a switch to selectively couple the snubber circuit to the transformer; and
a switch control circuit to control the switch to couple or decouple the snubber circuit to the transformer based on a selected output voltage of the transformer.

2. The device of claim 1, wherein the switch control circuit comprises a switch winding electromagnetically coupled to the secondary winding.

3. The device of claim 2, wherein the switch control circuit further comprises a capacitor in parallel with the switch winding and a Zener diode connected to the capacitor, the Zener diode connected to the switch to turn on the switch to couple the snubber circuit to the transformer during breakdown.

4. The device of claim 2, wherein a turn ratio of the switch winding to the secondary winding defines a threshold voltage, wherein when the selected output voltage exceeds the threshold voltage the snubber circuit is coupled to the transformer.

5. The device of claim 1, wherein the switch is in series with the snubber circuit.

6. A power adaptor comprising:
a transformer including a primary winding electromagnetically coupled to a secondary winding, the transformer to receive power at an input voltage and to output power at an output voltage;
a snubber circuit; and
a switch to couple the snubber circuit to the transformer, the switch electromagnetically coupled to the secondary winding of the transformer to selectively enable and disable the snubber circuit based on the output voltage as delivered by the secondary winding.

7. The power adaptor of claim 6, further comprising a switch winding coupled to the switch, the switch winding electromagnetically coupled to the secondary winding of the transformer, the switch winding to sense the output voltage to control the switch.

8. The power adaptor of claim 7, wherein the switch winding defines a threshold voltage, and the switch is controlled to enable the snubber circuit when the output voltage exceeds the threshold voltage.

9. The power adaptor of claim 8, wherein the switch is controlled to disable the snubber circuit when the output voltage does not exceed the threshold voltage.

10. The power adaptor of claim 9, further comprising a capacitor in parallel with the switch winding and a Zener diode connected to the capacitor, the Zener diode to control the switch to enable the snubber circuit during breakdown.

11. The power adaptor of claim 6, wherein the switch is in series with the snubber circuit.

12. A system comprising:
a power adaptor including:
a transformer to receive power at an input voltage and to output power at a selectable output voltage;
a snubber circuit; and
a switch to couple the snubber circuit to the transformer, the switch electromagnetically coupled to a winding of the transformer to selectively enable and disable the snubber circuit based on the output voltage as provided by the winding; and
a computer device to connect to the power adaptor to receive the output power from the adaptor, the computer device including a power controller to provide a request signal to the power adaptor to select the output voltage.

13. The system of claim 12, wherein the power adaptor is responsive to the request signal to provide the output voltage as indicated by the request signal.

14. The system of claim 12, wherein the power adaptor further comprises a switch winding coupled to the switch, the switch winding electromagnetically coupled to the winding of the transformer, the switch winding to sense the output voltage to control the switch.

15. The system of claim 12, wherein the computer device further comprises a cell to be charged by the power adaptor.
